(19) United States
(12) Patent Application Publication
(10) Pub. No.: US 2009/0057368 A1
(43) Pub. Date: Mar. 5, 2009

(54) Impact-Force Adjusting Device for a Nailer

(76) Inventor: Wen-Pin LIN, Daya Township (TW)

Correspondence Address: Dr. BANGER SHIA, 102 Lindencrest Ct., Sugar Land, TX, 77479-5201, US

(21) Appl. No.: 11/845,754

(22) Filed: Aug. 27, 2007

(51) Int. Cl. B25C 1/00

(52) U.S. Cl. 227/147

(57) ABSTRACT

An impact-force adjusting device for a nailer comprises a housing, a driving member, an adjusting knob and a spring. The driving member is formed with one protrusion, and the housing is defined with one guide groove for insertion of the protrusion, such that the driving member is restricted to linearly move in the housing to and fro by the driving of the adjusting knob, so as to compress the spring to different degrees. Such arrangements not only have the advantages of simple structure and small volume, but also can prevent the adjusting knob from extending out of the housing.

### BACKGROUND OF THE INVENTION

1. Field of the Invention

The present invention relates to an impact-force adjusting device, and more particularly to an impact-force adjusting device for a nailer which has the advantages of simple structure and small volume.

2. Description of the Prior Art

Referring to FIG. 1, a conventional impact-force adjusting device for a nailer comprises a housing 10 installed with a positioning member 11, an adjusting knob 12 and a spring 13. During operation, the spring 13 can be compressed to different degrees by rotating the adjusting knob 12, so as to adjust the impact force of the nailer. However, since the adjusting knob 12 must be abutted against the spring 13, the diameter of the adjusting knob 12 must be designed to be bigger than that of the spring 13, so that the volume of the adjusting knob 12 will be bigger. Further, the positioning member 11 is unmovable, so the adjusting knob 12 must be moved back and forth, as a result, the adjusting knob 12 will be protruded out of the housing 10 continuously. Thereby, such a device is unbeautiful and needs to be improved.

Referring to FIG. 2, another conventional impact-force adjusting device for a nailer comprises a housing 20 installed with a driving member 21, an adjusting knob 22 and a spring 23. The adjusting knob 22 doesn't need to move back and forth anymore, such that the adjusting knob 22 will not be protruded out of the housing 10. However, since it has to perform a multi-step adjustment, the adjusting knob 22 and the driving member 21 all need to be provided with additional cooperating structures, such that the structure of such a device is complex and the manufacturing cost is increased. And like the above-mentioned impact-force adjusting device for a nailer, the adjusting knob 12 must be mounted outside the driving member 21, so the diameter of the adjusting knob 12 must be designed to be bigger than that of the driving member 21, such that the volume of the adjusting knob 12 is bigger, which will not satisfy the demand for miniaturization.

The present invention has arisen to mitigate and/or obviate the afore-described disadvantages.

### SUMMARY OF THE INVENTION

The primary objective of the present invention is to provide an impact-force adjusting device for a nailer which can prevent an adjusting knob from extending out of a housing and can maintain the beauty of the products.

The second objective of the present invention is to provide an impact-force adjusting device for a nailer which not only has the advantages of simple structure and small volume, but also can reduce the manufacturing cost since an adjusting knob is received in a driving member, and the diameter of the adjusting knob is smaller than that of the driving member.

An impact-force adjusting device for a nailer of the present invention comprises:

a housing;

a driving member being mounted in the housing and defined with a threaded hole thereof;

an adjusting knob being rotatably threaded in the threaded hole of the driving member;

a spring being disposed in the housing, one end of the spring being abutted against one end of the driving member;

characterized in that: the driving member is formed with one protrusion, and the housing is defined with one guide groove for insertion of the protrusion, such that the driving member is restricted to linearly move in the housing to and fro by the driving of the adjusting knob, so as to compress the spring to different degrees.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional impact-force adjusting device for a nailer;

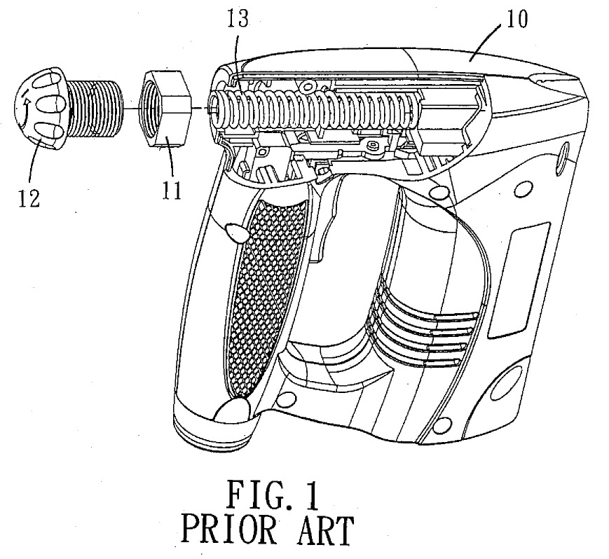

FIG. 2 is a perspective view of another conventional impact-force adjusting device for a nailer;

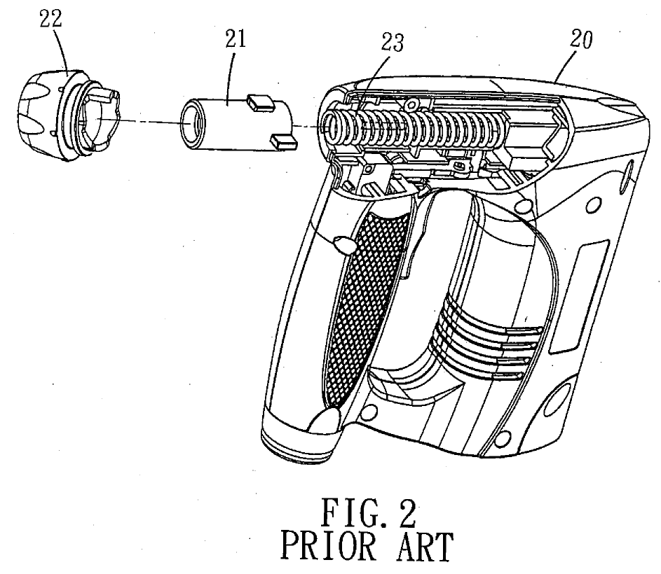

FIG. 3 is an exploded view of an impact-force adjusting device for a nailer in accordance with a first embodiment of the present invention;

FIG. 4 is a front view showing a housing;

FIG. 5 is a cross sectional view of the housing and a driving member;

FIG. 6 is an assembly perspective view of the impact-force adjusting device for a nailer in accordance with the present invention;

FIG. 7 is a partial cross sectional view showing the driving member not being moved forward;

FIG. 8 is another partial cross sectional view showing the driving member being moved forward;

FIG. 9 is a cross sectional view showing the driving member being moved forward;

FIG. 10 is an exploded view of the impact-force adjusting device for a nailer in accordance with a second embodiment of the present invention; and

FIG. 11 is a cross sectional view of the housing and the driving member in accordance with the second embodiment of the present invention.

### DETAILED DESCRIPTION OF THE PREFERRED EMBODIMENTS

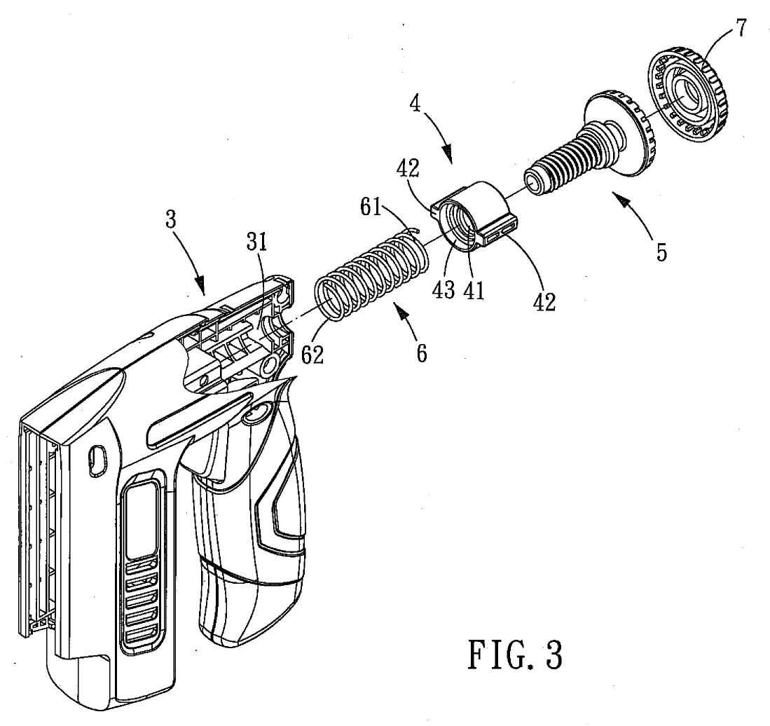

Referring to FIG. 3, an impact-force adjusting device for a nailer in accordance with the present invention comprises a housing 3, a driving member 4, an adjusting knob 5 and a spring 6.

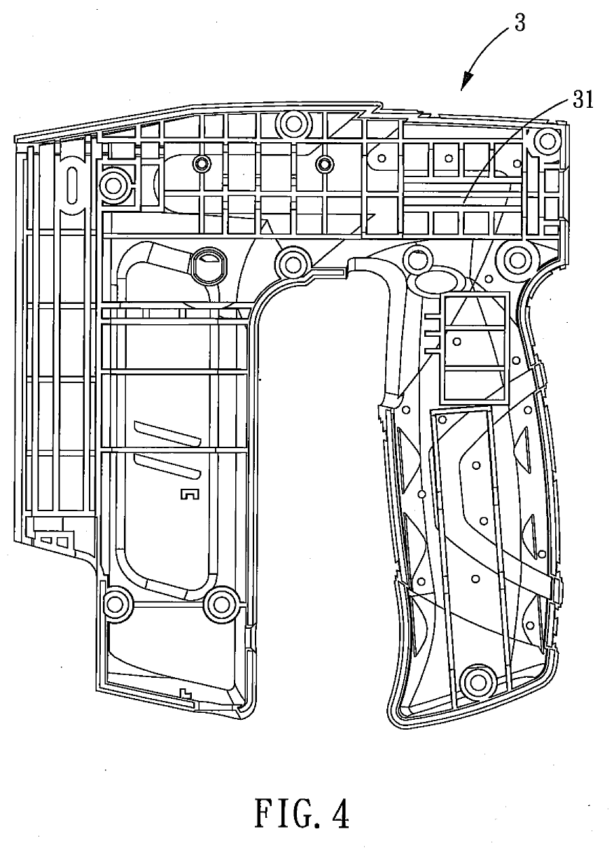

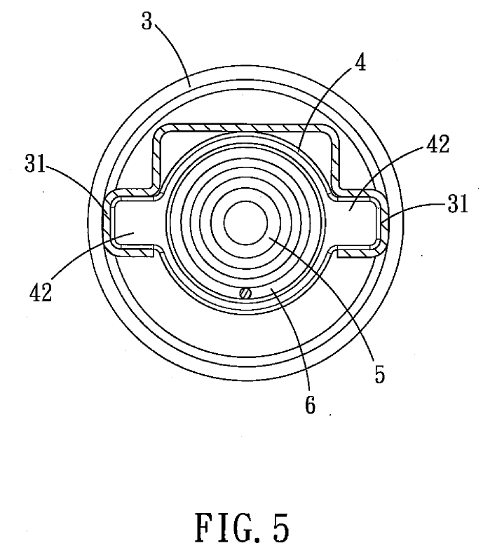

The structure of the housing 3 is the same as that of a conventional housing, which includes left and right half portions, and the difference is that in a suitable position of an inner surface of both sides of the housing 3 of the present invention is formed a guide groove 31, respectively (referring further to FIGS. 4 and 5).

The driving member 4 is mounted in the housing 3 and is defined with a threaded hole 41, and the driving member 4 is formed with two protrusions 42 to be inserted in the guide grooves 31 of the housing 3, respectively.

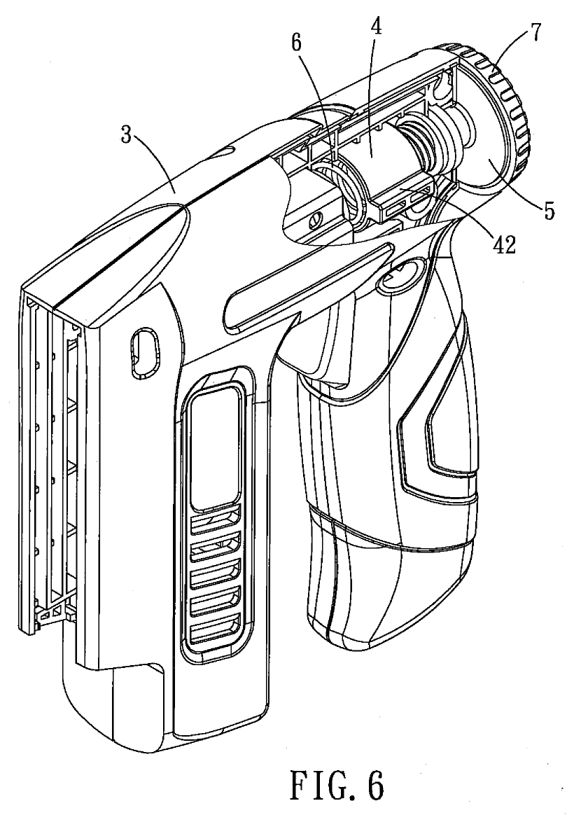

Referring to FIG. 6, the adjusting knob 5 is rotatably threaded in the threaded hole 41 of the driving member 4, and a cover 7 covers the adjusting knob 5 for providing a nice and neat appearance.

The spring 6 is disposed in the housing 3. One end 61 of the spring 6 is inserted in a groove 43 of one end of the driving member 4, such that the end 61 is abutted against one end of the driving member 4 stably, and the other end of the spring 6 is abutted against an impact member (not shown).

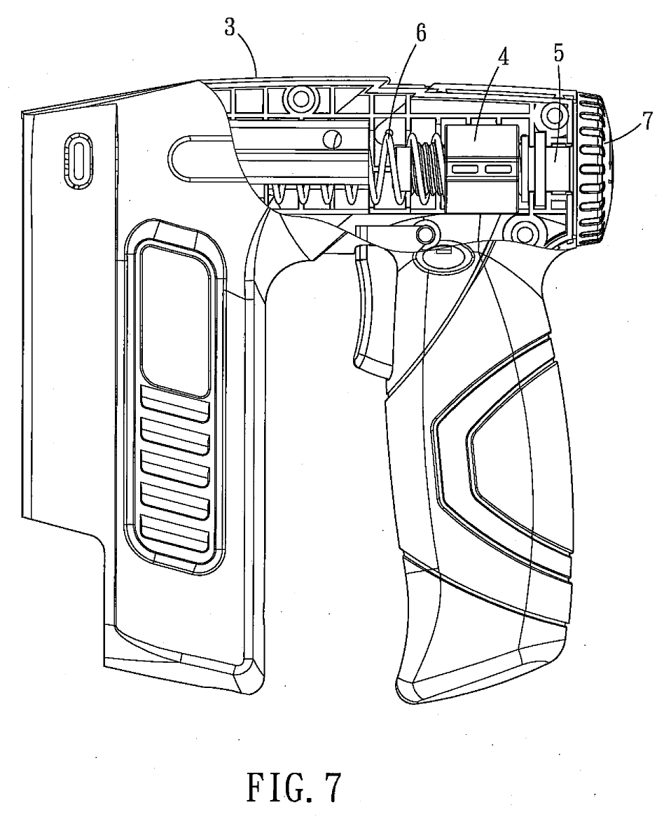

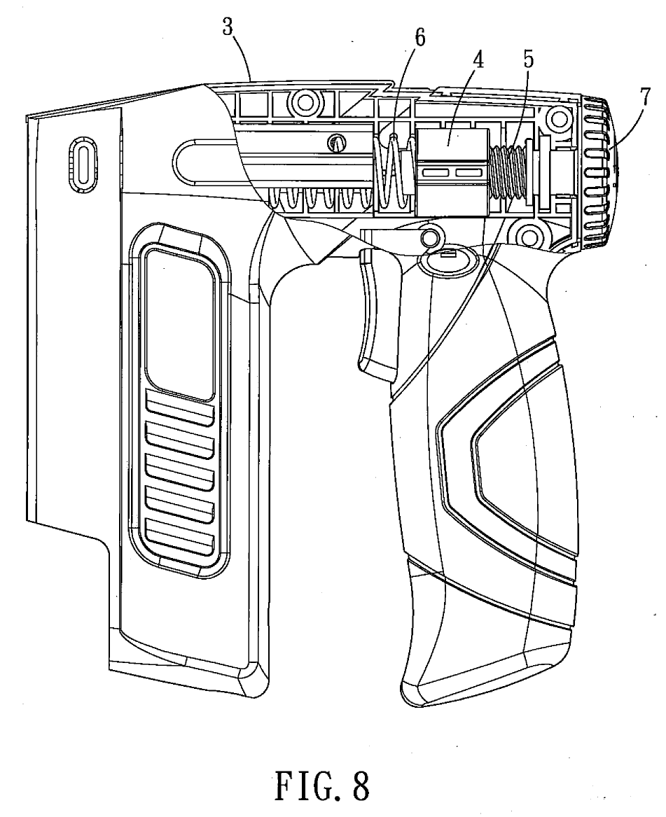

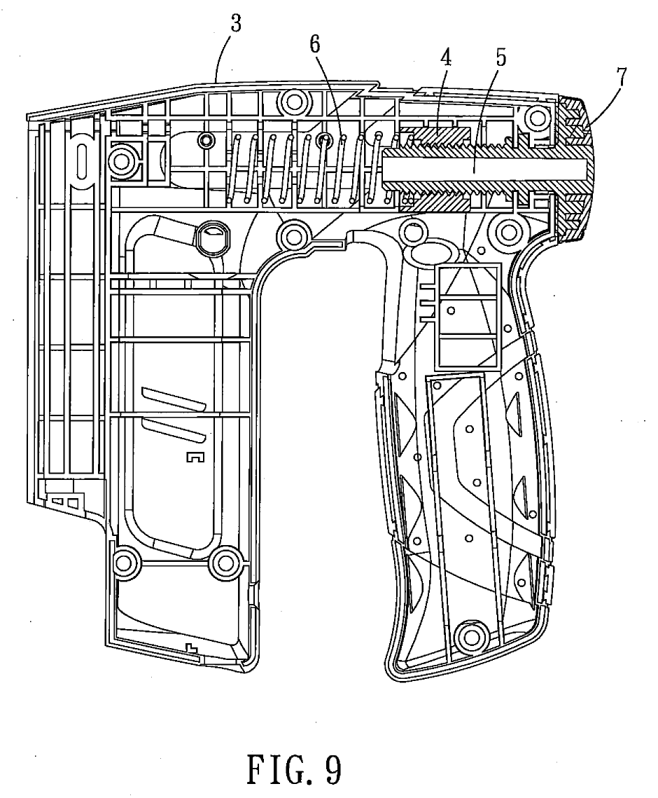

Referring to FIG. 7, when the adjusting knob 5 is threaded with the driving member 4, the extended spring 6 pushes the driving member 4 to move forward by rotating the adjusting knob 5 in a positive direction. And the protrusions 42 of the driving member 4 are stably moved to the positions as shown in FIGS. 8 and 9 under the guidance of the guide grooves 31. At this time, the spring 6 is compressed to store energy, so as to improve the impact force of the nailer. Contrarily, when the adjusting knob 5 is rotated in a negative direction, the driving member 4 will be moved backward and the spring 6 will be extended, such that the energy stored in the spring 6 is relatively low, thus reducing the impact force of the nailer.

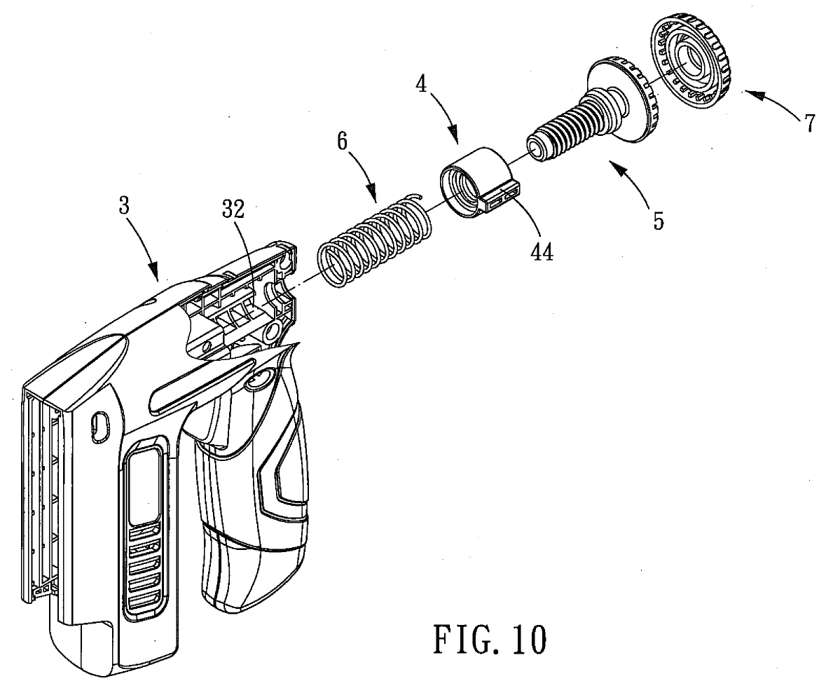

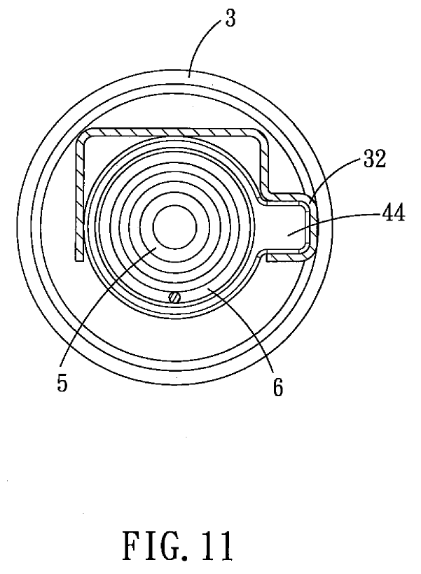

It is to be noted that to make the applicable range of the present invention wider, the driving member 4 can be formed with only one protrusion 44, and the housing 3 can be defined with only one guide groove 32 for insertion of the protrusion 44 as shown in FIGS. 10 and 11, such that the driving member 4 can also be moved to and fro by the driving of the adjusting knob 5.

To summarize, the impact force of the present invention is adjustable, so as to prevent the adjusting knob from extending out of the housing and to maintain the beauty of the products. In addition, since the adjusting knob is received in the driving member, and the diameter of the adjusting knob is smaller than that of the driving member, the present invention not only has the advantages of simple structure and small volume, but also can reduce the manufacturing cost.

While we have shown and described various embodiments in accordance with the present invention, it should be clear to those skilled in the art that further embodiments may be made without departing from the scope of the present invention.

What is claimed is:

1. An impact-force adjusting device for a nailer, comprising:
a housing;
a driving member being mounted in the housing and defined with a threaded hole thereof;
an adjusting knob rotatably threaded in the threaded hole of the driving member;
a spring disposed in the housing, one end of the spring being abutted against one end of the driving member;
characterized in that: the driving member is formed with one protrusion, and the housing is defined with one guide groove for insertion of the protrusion, such that the driving member is restricted to linearly move in the housing to and fro by the driving of the adjusting knob, so as to compress the spring to different degrees.

2. The impact-force adjusting device for a nailer as claimed in claim 1, wherein the driving member is formed with two protrusions to be inserted in two guide grooves of the housing, respectively.

3. The impact-force adjusting device for a nailer as claimed in claim 1, wherein a cover covers the adjusting knob.
